(19) United States
(12) Patent Application Publication
(10) Pub. No.: US 2008/0179245 A1
(43) Pub. Date: Jul. 31, 2008

(54) Crossflow Filter Membrane, Membrane Module, Connecting Element for Connecting Module Cushions, Method for Manufacturing a Module Element, Module for Crossflow Filtration, Method for Crossflow Filtration and Use of a Filter

(75) Inventors: Ulrich Gans, Kradolf-Schonenberg (CH); Jurgen Ebert, Wil (CH); Werner Loser, Oberuzwil (CH)

Correspondence Address: SHOEMAKER AND MATTARE, LTD, 10 POST OFFICE ROAD - SUITE 110, SILVER SPRING, MD, 20910, US

(73) Assignee: FILTROX AG, St. Gallen (CH)

(21) Appl. No.: 11/911,835

(22) PCT Filed: May 2, 2006
(86) PCT No.: PCT/EP2006/061965

§ 371 Date: Oct. 18, 2007

(30) Foreign Application Priority Data
May 4, 2005 (EP) 05103728.1

(51) Int. Cl. B01D 29/62; B01D 29/05; B01D 29/52; B01D 29/46; B01D 29/31; E04B 1/16

(52) U.S. Cl. 210/637; 210/636; 210/253; 210/340; 210/491; 210/483; 264/35

(57) ABSTRACT

The invention relates to a crossflow filter membrane comprising an active layer whose size is equal to or greater that 1 mm. Said crossflow filter membrane makes it possible to simultaneously carry out a crossflow filtration along a surface and a deep-bed filtration in the membrane depth. A connecting element for connecting module pads, a method for producing said connecting element and a crossflow filtering module are also disclosed. The connecting element supported by a filter pad surface on the side of unfiltered fluid closes an unfiltered fluid area for preventing a filtrate flowing and is provided with at least one closure element positively connectable to at least one other connecting element.

The invention relates to a crossflow filter membrane, a membrane module, a connecting element for connecting module cushions, a method for manufacturing a module element, a module for crossflow filtration, the use of a filter and a method for crossflow filtration as claimed in the independent patent claims.

The use of crossflow filters for filtering liquids is known in the prior art. Examples of crossflow filters can be found in EP 1 302 227 or EP 208 405.

Membranes with a thin active region of less than 20 μm are used for crossflow filters. Active region is understood to refer to that region of the membrane in which the actual filtration takes place. In the case of crossflow filter membranes this is usually only a small portion in the thickness of the membrane. The rest of the membrane serves as a supporting body and does not have any decisive influence on the filtration. The membranes are composed in particular of plastic or ceramic or else of glass or metal. An example of ceramic membranes can be found in DE 198 46 041.

Ceramic membranes are relatively high in cost. The throughflow rates are limited. For the economy of such membranes to continue to be ensured it is necessary for them to be regenerated regularly and used repeatedly. Plastic membranes are certainly less expensive but have a significantly shorter service life than ceramic membranes.

The membranes are regenerated using cleaning media. For the regeneration, methods are used, for example, which are based on oxidation or require strong lyes or acids. These methods are expensive and risky. On the one hand, the membranes can be damaged during the reconditioning, and on the other hand residues of the cleaning medium can adversely affect the quality of the filtrate. In particular, if fermented liquids, for example foodstuffs, are filtered, residues of the cleaning medium can have adverse consequences.

Membrane modules which comprise a filter cushion composed of two filter membranes which are arranged parallel to one another are known from the prior art, for example from EP 1475 142, SU 1352701 or SU 788480, with one filtrate discharge duct being formed on the filtrate side, and which have at least one discharge region for carrying away permeate, collected in the filtrate discharge duct, into a filtrate outflow. Connecting regions are embodied around the discharge region on the two unfiltrate-side surfaces of the filter cushion. After the membrane modules have been stacked, these connecting regions can be fused to one another. This prevents unfiltered liquid passing from the unfiltrate region between the membrane modules and into the filtrate outflow.

On the one hand, the connecting regions permit the permeate to flow out of the filter cushions but, on the other hand, they have to close off the spaces between unfiltrate-side surfaces of adjacent filter cushions in a liquid-tight fashion with respect to the filtrate outflow. This requires precise fabrication and a post-processing step when the fused connections are formed between the combined module elements.

One object of the present invention is to overcome the disadvantages of what is known and in particular to provide a membrane for the crossflow filtration which can be manufactured cost-effectively and can be used with high throughflow rates. Furthermore, it is an object of the invention to ensure simple handling of the filter. In addition, the intention is that module elements will be provided which are cost-effective to manufacture, easy to mount, can easily be combined to form stacks and in addition provide a good filtering effect.

These and further objects are achieved with a membrane, a membrane module, a connecting element, a module, a method and a use according to the independent patent claims.

The crossflow filter membrane according to the invention has an active region of at least 1 mm, preferably over 2 mm. The active region preferably extends over the entire membrane thickness so that the membrane can be used for filtration over its entire thickness.

The inventors have found that membranes with a comparatively thick active region are particularly well suited to crossflow filtration.

The membrane is preferably constructed from a framework of fibers. The fibers may be organic or inorganic in origin. Cellulose fibers are particularly suitable. Additives such as diatomaceous earth, perlites or further fillers can be embedded in the three-dimensional fiber framework.

According to a further aspect of the invention, the basic structure of the membrane is based on a framework composed of cellulose fibers. In this context, cellulose fibers of different origins can be used. Not only wood fibers but also other fibers, for example hemp fibers, can be used or mixed with one another. However, membranes which are based on other fiber-containing compounds, for example on plastic fibers, metal fibers or glass fibers, are also conceivable.

The membrane can also be of asymmetrical design, i.e. the fiber density, the fiber sizes and/or the additives are not distributed homogenously over the entire membrane thickness. The distribution of the fibers and the additives is preferably selected in such a way that the membrane for filtering relatively coarse particles is embodied in the region adjacent to the unfiltrate-side surface of the membrane. Toward the filtrate side, the structure of the membrane changes in such a way that relatively fine portions are filtered out of the liquid the closer a corresponding membrane region lies to the filtrate-side surface. The finest particles are retained in a region adjacent to the filtrate-side surface of the membrane. An advantage with this arrangement is that of an overall greater flow through the membrane. Coarse particles are retained at the surface in the crossflow principle. Relatively fine particles are retained in the interior of the membrane when the liquid passes through the membrane. Owing to the filtration of fine particles in the depth of the membrane, the membrane can be embodied at the unfiltrate-side surface in such a way that only the largest particles are retained. The throughflow rate is as a result not adversely affected to a significant extent. In particular it is conceivable to provide additives, in particular diatomaceous earth in a larger concentration in a region adjacent to the filtrate side of the membrane.

Fibers with a length of 0.5 mm to 10 mm can typically be used.

Additives are particularly advantageously added to the basic structure of the membrane. These may be, for example, diatomaceous earths or perlites. Other examples of additives are generally charged particles or polar compounds which attract electrically charged particles of dirt. These improve the filtration performance of the membrane through increased adsorption. Further conceivable additives are resins, chitin or fibers with other properties, for example in terms of length or tensile strength, as the main fibers of the basic structure. In particular it is conceivable to increase the tensile strength of the membrane by adding hemp fibers to the membrane and/or by using a comparatively high proportion of resin. The resistance to tearing can be over 100N/50 mm, typically 400N/50 mm.

Crossflow filter membranes according to the present invention can be manufactured inexpensively. They have high throughflow rates over a relatively long time. Furthermore, they can easily be cleaned during operation. Owing to the low costs, they could also be used as disposable products. However, the membranes are advantageously regenerated repeatedly.

During crossflow filtration, a high crossflow speed is usually used with the intention of preventing deposits forming on the surface of the membrane and blocking it. With a membrane according to the present invention it is possible, in particular, for fine particles and colloids to be trapped in the three-dimensional structure of the membrane, that is to say in the depth of the membrane. A larger pore size of the membrane can be selected especially in the unfiltrate-side surface region than in conventional crossflow membranes. As a result, the flow through the membrane is greater, which permits an improved filter performance. In conventional membranes, a relatively high crossflow speed is used in order to remove particles which have become deposited on the surface. In particular colloids have the tendency to adhere strongly to the surface. For this reason, high crossflow speeds are necessary. According to the present embodiment, colloidal substances are trapped in the depth of the membrane. There is no coherent covering layer of colloidal substances which are difficult to remove. The accumulation of coarse particles which is at most deposited on the surface of the membrane can be removed with a comparatively low crossflow speed. As a result, less energy is used for pumping and for cooling. The pressure gradient across the membrane is correspondingly reduced. The membrane particularly advantageously has reversibly compressible properties. This means that the membrane is compressed under pressure but relaxes again if the pressure is released. Given a pressure gradient of 1 bar, the membrane is advantageously compressed by 50% of the thickness and it recovers to at least 95% of the thickness after the pressure difference has been eliminated. It is particularly advantageous that the membrane recovers completely after the pressure has been eliminated.

It has become apparent that a reversibly compressible membrane can be cleaned directly in the filter system particularly easily. Owing to the transmembrane pressure, the membrane is compressed during operation. For the purpose of cleaning, the transmembrane pressure is reduced by process engineering means. As a result, the membrane expands again and the pores widen. Particles contained therein can easily be flushed out with a liquid, for example with water.

If further regeneration of the membrane is desired, gentle cleaning can be performed by means of a weak lye. The filter performance of the regenerated membrane corresponds to the original filter performance.

The framework of the membrane is preferably constructed in such a way that the retention rate of the membrane according to the invention corresponds to the retention rate of a conventional plastic or ceramic membrane with a pore size of 0.2 μm to 1.2 μm when filtering beer. The membrane according to the invention is preferably constructed here in such a way that a logarithmic reduction rate for yeast cells of the drinks industry of at least 10¹⁰ is achieved. Pore sizes of the membrane according to the invention can be determined, for example, with a “capillary flow analysis” measuring device from Porous Materials, Inc. Ithaca, N.Y., USA. The membrane framework is preferably constructed in such a way that the smallest detected pore is in the range from approximately 0.5 μm to 1 μm, the largest detected pore is in the range between 10 μm and 20 μm, and the average pore size (“mean flow pore diameter”) is between 2 μm and 8 μm, preferably approximately between 2 μm and 4 μm. Owing to the filter effect in the depth of the membrane according to the invention, use can be made of such comparatively large pore sizes to achieve the same retention rates as are obtained with conventional membranes with relatively small pore sizes.

In order to protect the surface of the membrane against damage and wear, it is advantageously provided with a protective layer and/or a spacer element. Such a spacer element or such a protective layer can be provided both on the filtrate-side surface of the membrane and on the unfiltrate-side surface of the membrane. In particular, the protective layer on the unfiltrate-side surface is advantageous. This protective layer or the spacer element can be composed, for example, of a woven and/or plastic provided with openings. With such a spacer element it is possible to extend the service life of the membrane further. The spacer element can be securely connected to the membrane but can also be merely placed on it or weakly fixed to it and pressed on by the operating pressure. For example, a woven fleece in combination with a plastic mesh which serves as a spacer element can be used to form liquid ducts. A spacer element in which the grating size corresponds approximately to the fiber length of the membrane lying below it is suitable. As a result, a particularly good support is provided for the membrane located underneath. This prevents an adverse effect on the membrane as a result of fibers which protrude or project into intermediate spaces of the grating.

The membrane according to the invention is also essentially free of aluminum, iron or heavy metals. Furthermore, the membrane is preferably low in pyrogenes 0.12 EU/ml (endotoxin unit) and low in ions.

A module element for installation in a crossflow filter is also a component of the invention. The module element according to the invention comprises at least one membrane having the previously described properties. The module element preferably comprises feed lines and/or draw lines for the unfiltrate or the filtrate. The module element advantageously comprises at least two membranes. In each module element two membranes are particularly advantageously connected to one another in each case in such a way that the filtrate outflow is arranged between the two membranes and is insulated from the unfiltrate chamber. A plurality of module elements can be connected to one another to form a stack. At least one module element or a stack of module elements is clamped into a housing. This forms a filter module. The use of module elements simplifies and speeds up the exchange of the used membranes for new membranes. This permits savings in terms of time and costs when performing maintenance on the filter.

The object on which the invention is based is achieved by means of a module element, in particular having the properties described above, which module element comprises a filter cushion composed of two filter membranes which are arranged parallel to one another, with a filtrate discharge duct being formed on the filtrate side, and which module element has at least one discharge region for carrying away permeate, which has collected in the filtrate discharge duct, into a filtrate outflow. The module element comprises at least one connecting element which defines the filtrate outflow and which bears, adjacent to the at least one discharge region, against an unfiltrate-side surface of the filter cushion by means of which a region in which unfiltrate is located can be closed off from the filtrate outflow in a seal-forming fashion, and which has at least one closure element for a positively locking engagement with at least one closure element of at least one further connecting element.

The filter module independently achieves the object on which the invention is based, in particular also in combination with the previously described membranes.

The filter cushion is constructed in particular from filter membrane plates whose edges are also arranged parallel to one another and form the edge of the filter cushion.

The connecting element seals the filtrate outflow off from the unfiltrate which is located on the side of the filter cushion against which the connecting element bears.

The module element itself has, with the connecting element, an element by means of which it can be connected to further connecting elements. The attachment of the module element and the sealing-off with respect to the unfiltrate region can therefore be carried out without further attachment means or sealing means or a further fabrication step, which facilitates the manufacture and the assembly and reduces the associated costs.

The module element preferably possesses a connecting element which can be connected on both sides to at least one connecting element of the same type of at least one further module element.

The connecting elements permit connection on both sides, that is to say in both directions of the surface perpendiculars of the filter cushion. As a result, the module elements can be connected to form module stacks, with the filtrate outflow being formed by the connecting elements and being sealed off with respect to the unfiltrate.

Each connecting element can at the same time be a counterpart to a connecting element of the same type. Correspondingly, each stackable module element, including the connecting element, can be embodied in the same way, and the shape of the connecting elements can be identical. This in turn simplifies the manufacture since only one type of connecting element has to be fabricated. Only one mold is required in the case of manufacture by injection molding. The mounting is made easier since no particular arrangement or sequence of the connecting elements has to be complied with.

The closure elements are advantageously an integral component of the connecting elements.

The at least one closure element preferably comprises pins and recesses, with the recesses serving to receive pins of an adjacent connecting element and to form the snap-action closure. In an analogous fashion, the purpose of the pins is to be introduced into recesses of a further adjacent connecting element.

Module elements with such connecting elements can be attached to one another without a tool or just with a simple pressing tool.

The connecting elements abut against an unfiltrate-side surface of the membrane cushion in the vicinity of the discharge region. They prevent unfiltrate passing into the filtrate outflow. For this purpose, the connecting elements advantageously have a first bearing face with which they bear, adjacent to the discharge region, against an unfiltrate-side surface of the membrane cushion, and furthermore a further bearing face for a membrane cushion of a further module element. The space between two adjacent filter cushions is closed in the surroundings of the at least one discharge region by the connecting element so that no unfiltrate from the unfiltrate region which is formed between the unfiltrate-side surfaces of two module elements of the same type which are arranged parallel to one another can pass into the filtrate outflow.

The closure elements of the connecting elements ensure a specific distance between two adjacent connecting elements. This distance between facing bearing faces of adjacent connecting elements is dimensioned such that it is adapted to the thickness of a filter cushion. The discharge region of a filter cushion can be clamped in between the bearing faces of two adjacent connecting elements.

In order to ensure contact between the connecting element and the filter cushion which is sealed as well as possible, projections which hook into the membrane are preferably provided on the at least one connecting element. The projections are advantageously located on the bearing face and press into the membrane.

The discharge region of a module element is preferably arranged in the middle of the surface of the filter cushion, particularly preferably centrally. The discharge region is in particular in the form of a circle. In this case, the connecting element can be embodied as an annular flange which surrounds the filtrate outflow.

In one advantageous embodiment of the invention, the module element has a filter cushion whose edge region is closed off in a liquid-tight fashion, said edge region surrounding the entire edge of the filter cushion apart from the at least one discharge region.

The filter cushion is at least composed of two plate-shaped membranes which are arranged parallel to one another and between which the filtrate discharge duct is formed. The intention is that a transfer of liquid from the unfiltrate side to the filtrate side will occur exclusively through the membrane. The edge of the cushion must therefore be closed. The only exception is the discharge region through which the permeate passes into the filtrate outflow. In the area surrounding the discharge region the unfiltrate is prevented from passing to the filtrate side by the connecting elements.

The edge region can surround the entire outer edge of the filter cushion if the discharge region is arranged inside the membrane surface, for example as a central opening.

The edge region which is closed off in a liquid-tight fashion can be embodied as a nonreleasable frame made of plastic, which increases the dimensional stability of the cushion. The filter cushion is then in one part and can be mounted easily.

The closing-off process is preferably carried out by encapsulation by injection molding or by fusing, which are cost-effective methods which ensure a tight seal.

The edge region which is closed off in a seal-forming fashion is preferably embodied in such a way that edge regions of adjacent module elements which abut against one another, with the exception of regions in which unfiltrate can flow in and out, form a positive locking engagement.

In one advantageous embodiment of the module element, pins and recesses for a snap-fit closure with an adjacent module element are arranged on the edge region. An edge region can preferably be connected on both sides to an edge region of the same type of at least a further module element. Module elements of the same type are aligned as they are positioned one on the other, which makes stacking easier.

On the filtrate side, a filtrate spacer element advantageously forms a filtrate discharge duct between every two membranes, by means of which duct the filtrate is conducted into a filtrate outflow through a connecting piece. This filtrate outflow is isolated from the inflow and outflow for the unfiltrate.

In one advantageous embodiment, the filtrate spacer element has, at least in part of its edge region, at least one stop against which at least one membrane abuts.

The stop can be embodied, for example, as a surface which is arranged perpendicular to the surface of the filtrate spacer element. The stop surface can extend in the direction of both membranes and thus form a stop for the two membranes. The edge of the membranes is protected by the stop and the mounting of the filter cushion is made easier since the outer contours of the membranes and of the filtrate spacer element can be aligned with one another by virtue of the stop.

In a further advantageous embodiment of the module cushion, the filtrate spacer element closes off the edge region of the filter cushion which, apart from the at least one discharge region, surrounds the entire edge of the filter cushion in a liquid-tight fashion. The filtrate spacer element can have a thickened portion, for example in the edge region, so that the edge region of the two membranes is completely filled in via the space, apart from in the discharge region. If the filtrate spacer element and membranes are permanently connected to one another at the edge region, for example by bonding, fusing or by pressing one onto the other, the edge region is closed off in a liquid-tight fashion.

In one preferred embodiment of the module element, non-woven inlays are located between the membranes and the filtrate spacer element. The nonwoven inlays prevent the filtrate spacer element pressing into the membrane and deforming or damaging it in the process.

Furthermore, plastic membrane inlays, preferably with a pore size between 0.1 μm and 0.6 μm, can be arranged between the membranes and the filtrate spacer element. The membrane inlays can ensure an additional filter effect and retain particles from the filtrate discharge duct. The plastic membrane inlays form, in particular, a safety barrier for particles which undesirably penetrate the membrane.

Above all it is important that such particles do not get into the filtrate outflow. It can therefore be sufficient if at least one plastic membrane inlay, for example with a pore size between 0.1 μm and 0.6 μm, is located in the flow-through cross section of the filtrate discharge duct, in particular in the area surrounding the discharge region. In this way, the discharge region can, for example, be closed off with a plastic membrane inlay.

A duct for unfiltrate is also preferably formed between the unfiltrate-side surfaces of adjacent membranes. This is appropriate in particular if a module element comprises two or more membranes. The duct for the unfiltrate is advantageously formed by an unfiltrate spacer element. An unfiltrate space which is formed between the unfiltrate-side surfaces of adjacent membranes is preferably opened on the side of the module.

The object on which the invention is based is also achieved by means of a module element, in particular having the properties described above, having an unfiltrate spacer element which has a groove structure. By means of the groove structure, the unfiltrate can be conducted across the membrane surface and preferably past the discharge region. The grooves have a shape which directs the unfiltrate from the inflow region to the outflow region and in the process the liquid flows as uniformly as possible over the membrane and past the discharge region.

The unfiltrate spacer element can be embodied in such a way that the discharge region is closed off with respect to unfiltrate in a liquid-tight fashion. In the area surrounding the discharge region, the unfiltrate spacer element fills in the unfiltrate-side space between two adjacent membranes.

In a separate embodiment, the connecting element and the unfiltrate spacer element can be embodied in one part.

In one advantageous embodiment, the unfiltrate spacer element has positioning tongues which engage in corresponding recesses in the edge region of the filter cushion. Unfiltrate spacer elements can thus easily be aligned with filter cushions, which simplifies the stacking of module elements.

For stackable module elements it is favorable if in particular components of the same type can be manufactured economically in large numbers. The unfiltrate spacer element is therefore preferably an injection-molded part.

The object on which the invention is based is also achieved by means of a connecting element. According to the invention, the connecting element serves to connect adjacent filter cushions composed of two filter membranes which are arranged parallel to one another, wherein a filtrate discharge duct is formed on the filtrate side between the membranes, having at least one discharge region for carrying away permeate which has collected in the filtrate discharge duct, said filtrate discharge duct opening into a filtrate outflow. Adjacent to the at least one discharge region, the connecting element can be applied to an unfiltrate-side surface of the filter cushion. By means of the connecting element, a region in which unfiltrate is located can be closed off in a seal-forming fashion with respect to the filtrate outflow, and the connecting element has at least one closure element for positive locking engagement with at least one closure element of at least one further connecting element.

The connecting element can advantageously be connected on both sides to at least one connecting element of the same type of at least one further module element.

The connecting element can be applied to, or plugged onto, a filter cushion so that the latter can be connected to further filter cushions without further resources and/or without a tool or with only a simple pressing tool, and the unfiltrate regions which are located between the filter cushions can be sealed off from the filtrate outflow.

A connecting element serves as a counterpart for further connecting elements of the same type. For this reason, just one type of connecting element is necessary to stack module elements.

The connecting element is preferably an injection-molded part which can be manufactured economically in large numbers.

Furthermore, the invention comprises a method for manufacturing a module element, in particular in accordance with the description above, having the following method steps: (i) stacking of a first membrane, a filtrate spacer element and a second membrane, (ii) encapsulation by injection molding of the edge, with the exception of the at least one discharge region, and (iii) applying connecting element.

At least one discharge region, preferably in the middle of the membrane surfaces, can be embodied by punching and/or cutting the stack. The at least one discharge region can alternatively already be formed during the fabrication or during the cutting of the membranes to size.

If appropriate, an unfiltrate spacer element can additionally be applied.

The module elements which are manufactured in this way can be stacked without a tool or with a simple pressing tool to form modules.

The invention also comprises a module for crossflow filtration which is composed of a stack of 2-100 module elements, according to the description above.

Furthermore, the invention comprises a method for crossflow filtration of a liquid, in which the liquid is conducted along a membrane, as previously described.

The liquid is advantageously conducted across the membrane at a flow rate between 0.1 and 2 m/s, in particular 0.1 to 1 m/s. In this speed range, a particularly efficient filter performance is possible. The energy for recirculating the liquid is reduced by the low speed compared to conventional methods.

The transmembrane pressure is typically between 0.1 and 2 bar.

The flow rate can advantageously be regulated by means of the membrane, for example by adjusting the transmembrane pressure across the membrane. The flow rate could be adjusted to a constant value, but a predetermined time profile can also be advantageous. The flow rate can be, for example, 100 to 2001/m² h for filtration of a beverage.

A further aspect of the invention relates to a method for cleaning the previously described crossflow filter membrane. In the method for cleaning the crossflow filter membrane, the transmembrane pressure is reduced compared to the pressure gradient during filtration. The reduction in the transmembrane pressure is advantageously at least 50%. The reduction in the pressure gradient causes the pores of the membrane to widen. The membrane can be cleaned gently with water or with a weak lye by forward and/or backward rinsing.

A membrane or a method such as previously described is particularly advantageously used for the crossflow filtration of liquids, in particular beverages. These include, in particular, beer or wine.

A further aspect of the invention relates to a method for filtering liquids. For this purpose, the liquid is conducted in crossflow mode along a membrane, with relatively coarse particles being retained at the surface of the membrane. The liquid which is freed of these coarse particles passes transversely through the membrane. According to the present invention, as the liquid which is partially prefiltered in this way passes through the membrane transversely relatively fine particles are retained in the depth of the membrane and filtered out of the liquid. This aspect of the invention therefore relates to a filtration method which combines crossflow filtration principles, which are known per se, with depth filtration principles, which are known per se, in one and the same filter membrane.

In the text which follows, a preferred embodiment of the invention will be explained with reference to figures, of which:

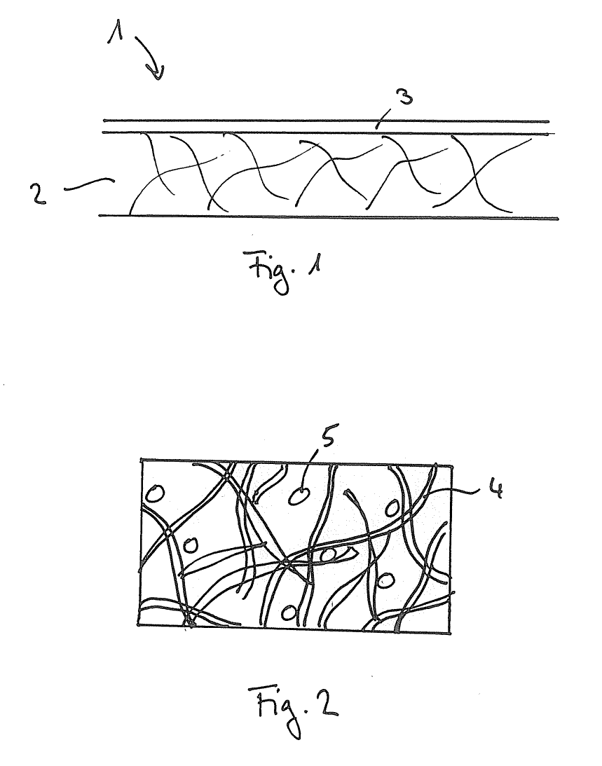

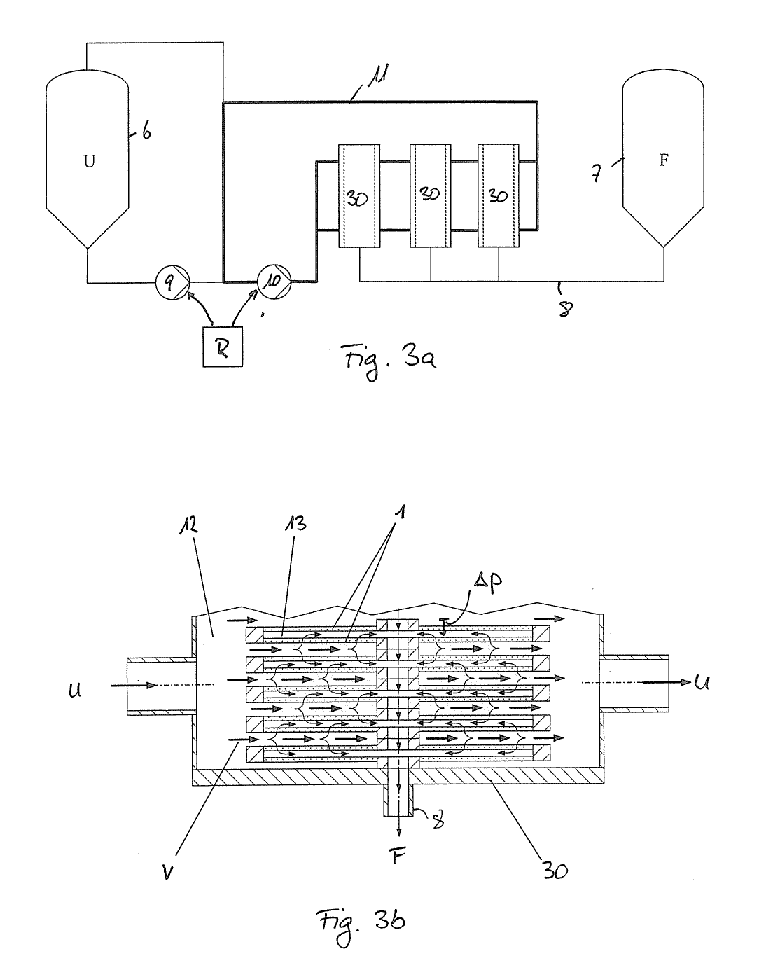

FIG. 1: is a schematic illustration of a membrane according to the invention,

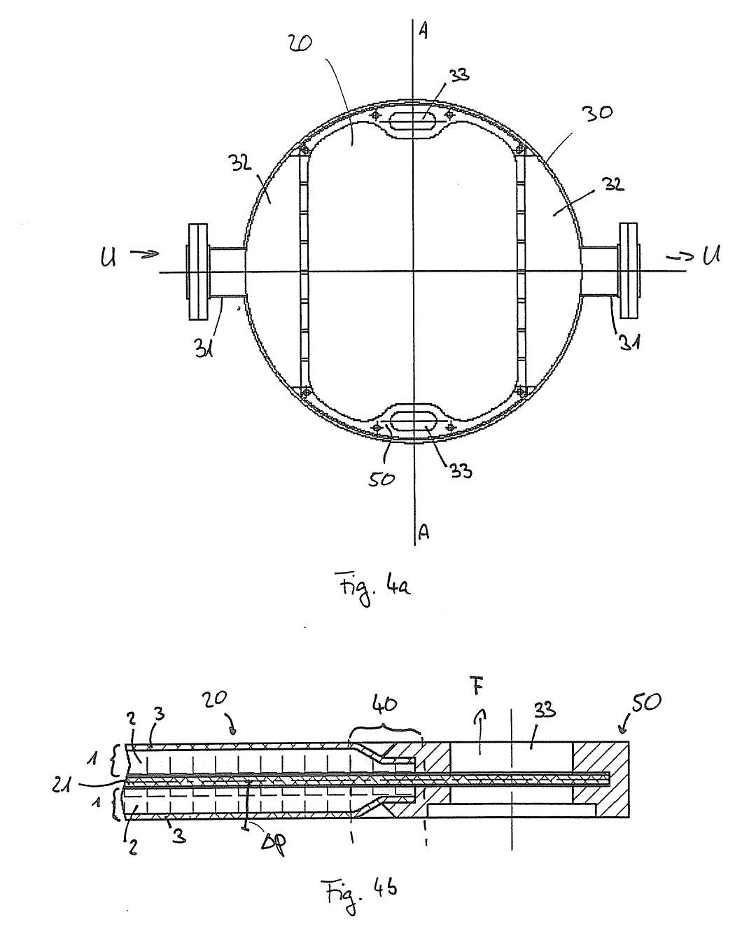

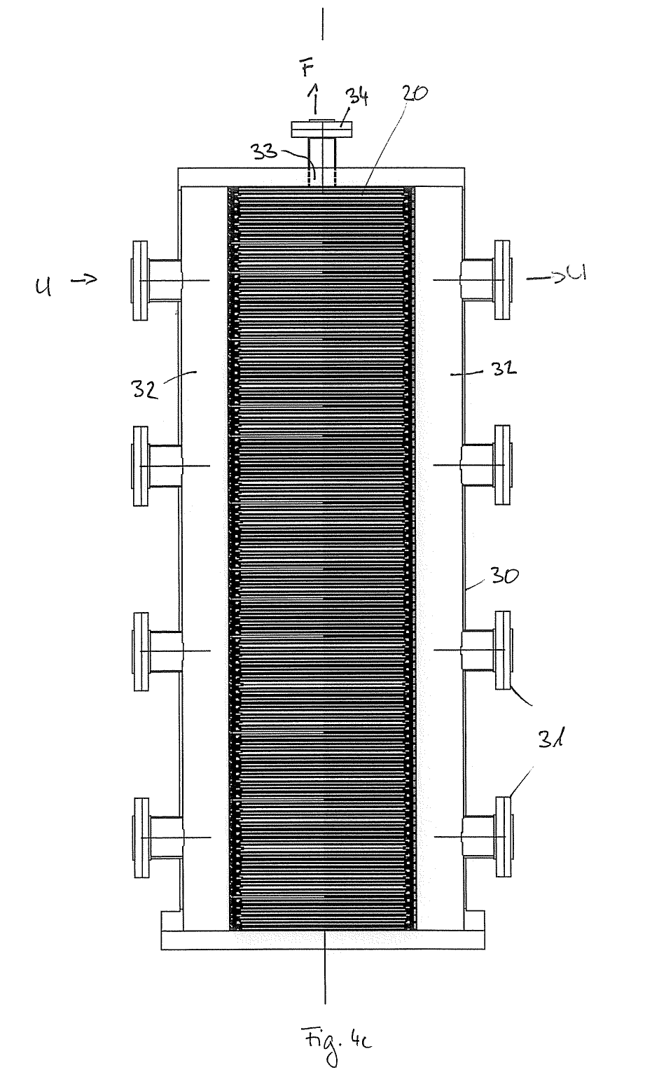

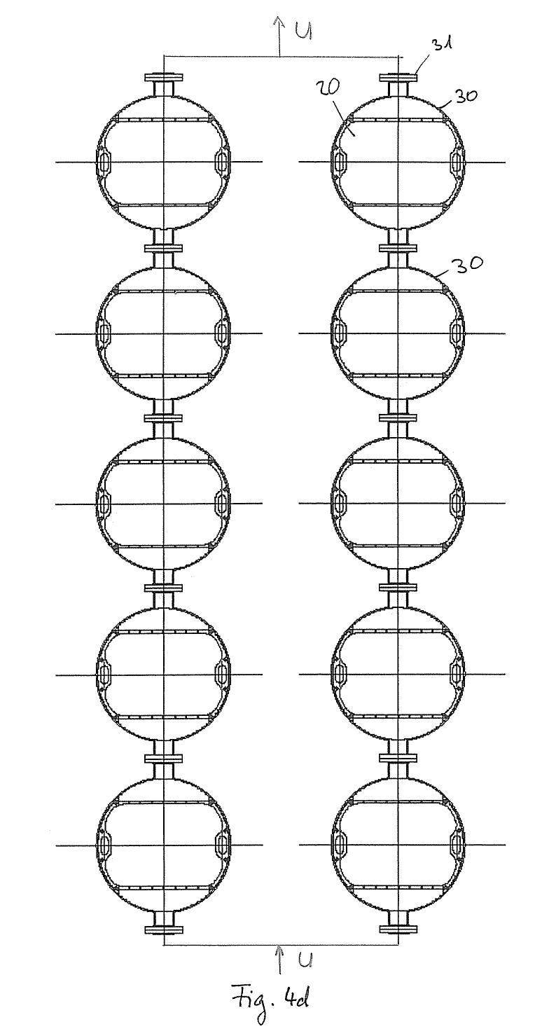

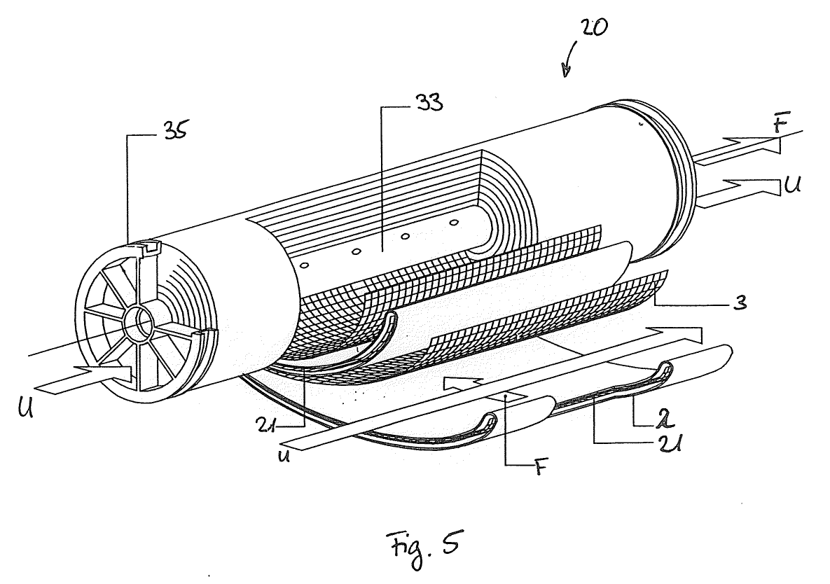

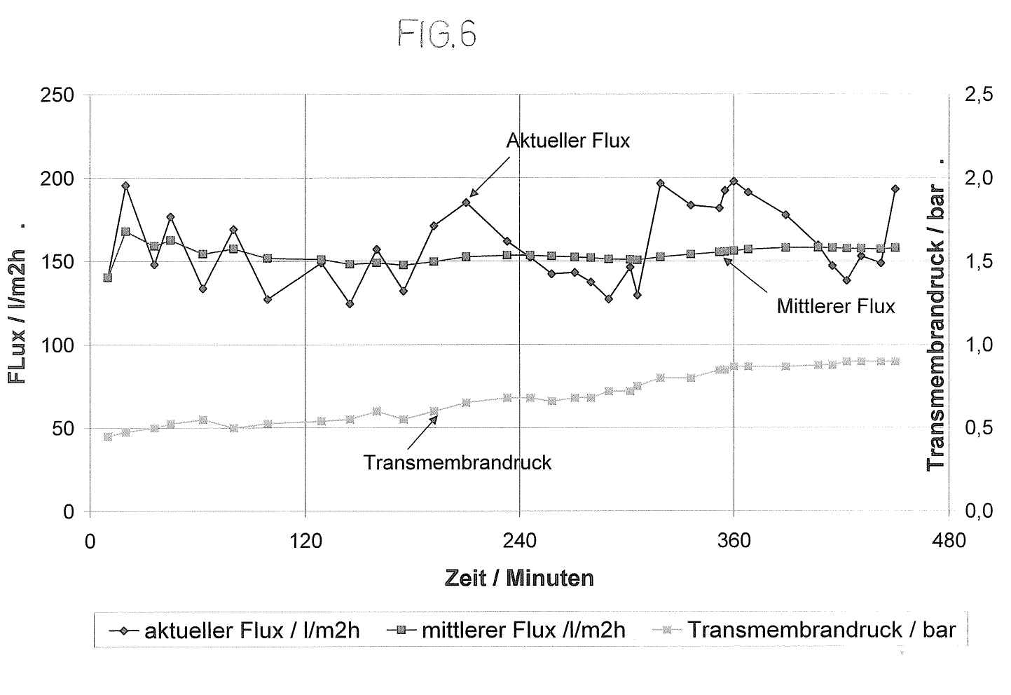

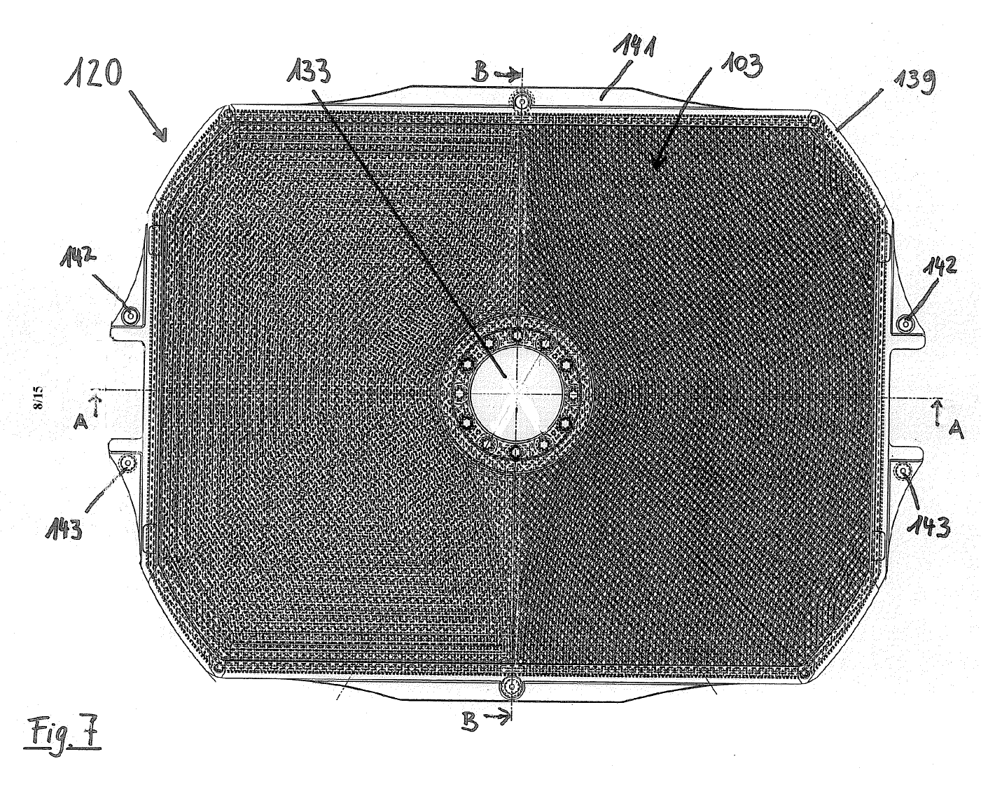

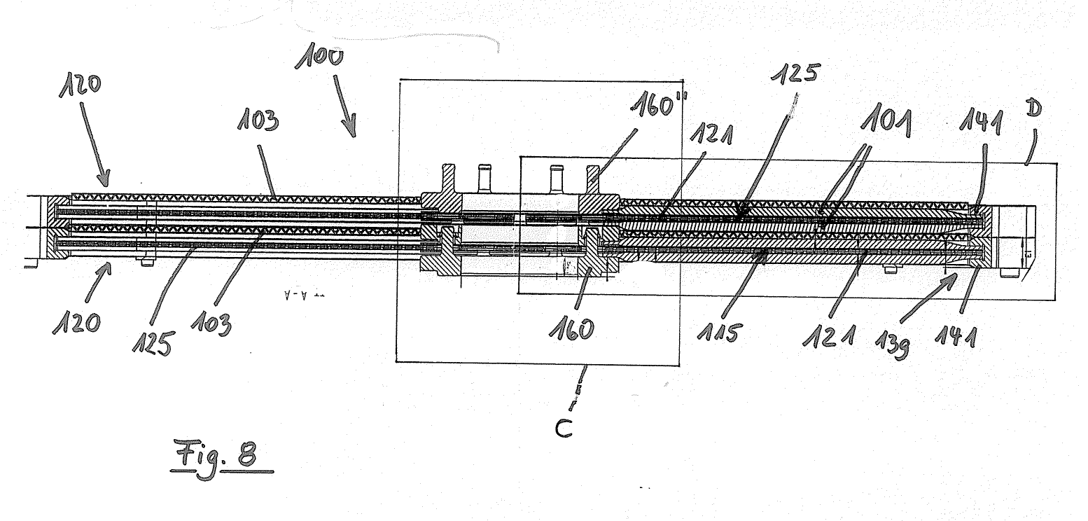

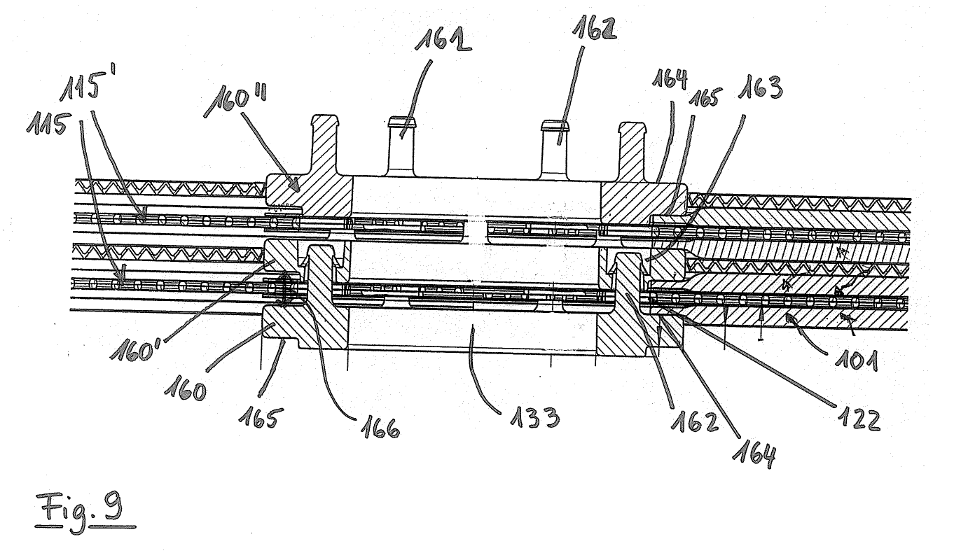

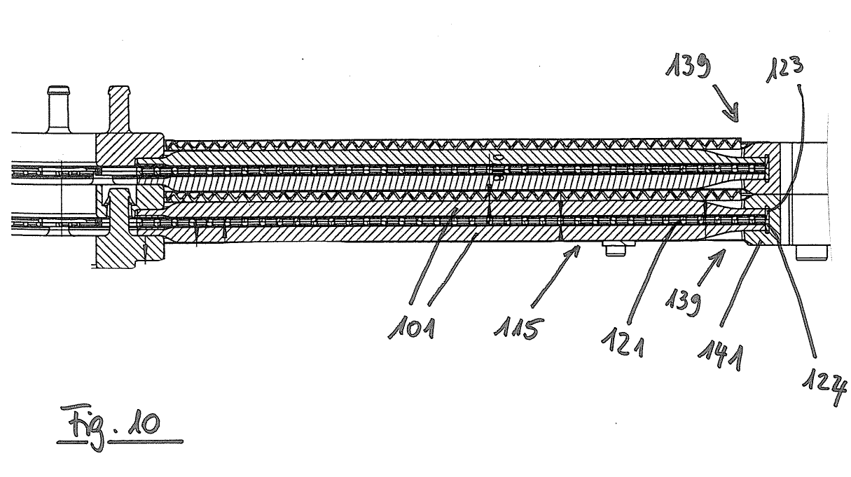

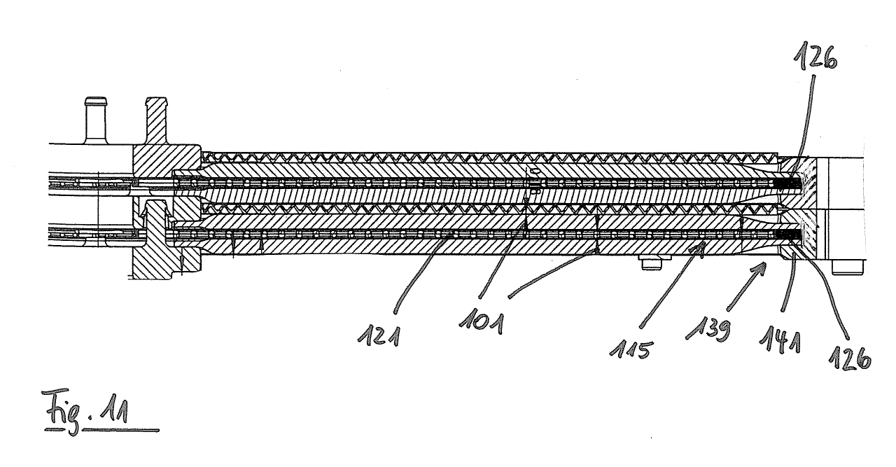

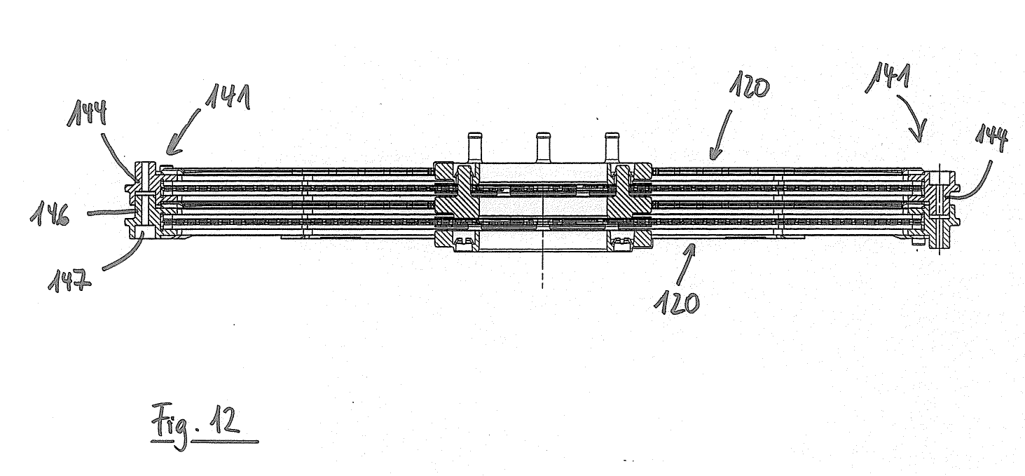

FIG. 2: is a schematic illustration of the region of the membrane according to FIG. 1 which is active in terms of filtering,

FIG. 3: is a schematic illustration of a crossflow filter with the membrane from FIG. 1,

FIGS. 4a-d: show a module element according to the invention and the installation of the module element in a housing,

FIG. 5: is an alternative embodiment of a module element,

FIG. 6: is a graphic illustration of transmembrane pressure and flux of a membrane according to the invention plotted over time,

FIG. 7: is a plan view of a module element according to the invention,

FIG. 8: is a sectional view of a plurality of stacked module elements along a section plane A-A in FIG. 7,

FIG. 9: shows an enlarged detail C of the illustration in FIG. 8 with the connecting elements of module elements,

FIG. 10: is an enlarged detail D of the illustration in FIG. 8 with edge regions of filter cushions,

FIG. 11: shows alternatively embodied edge regions of filter cushions,

FIG. 12: is a sectional view of a plurality of stacked module elements along a section plane B-B in FIG. 7,

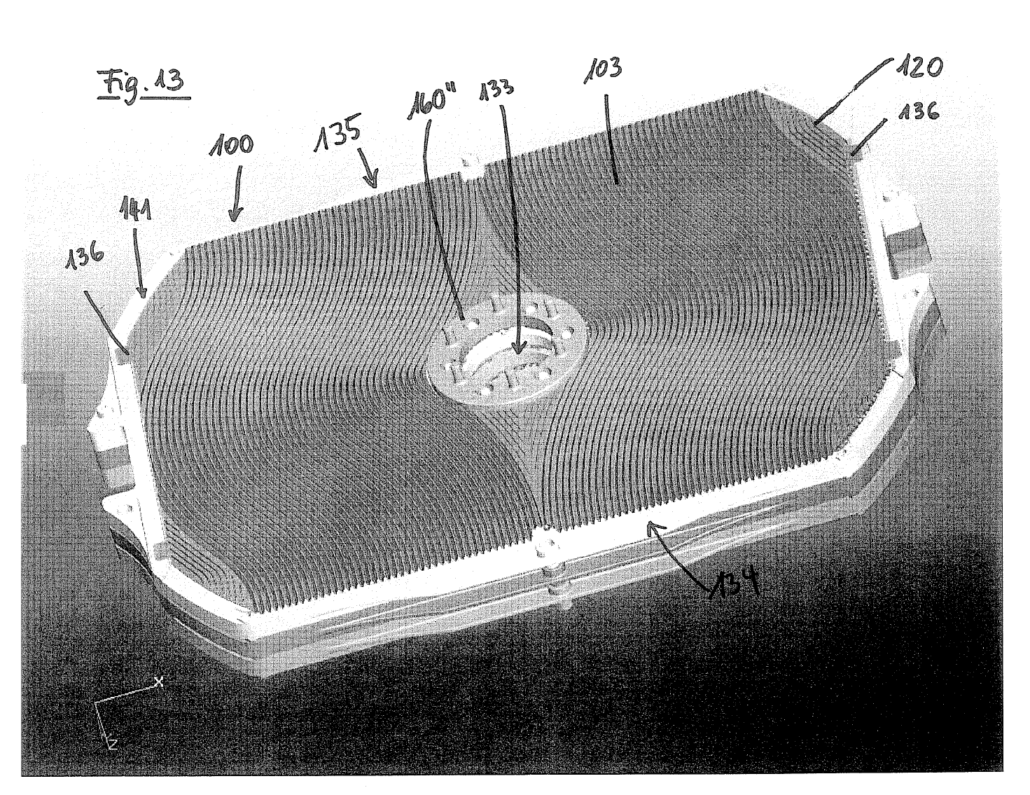

FIG. 13: is a perspective view of a stack of module elements with an unfiltrate spacer element; and

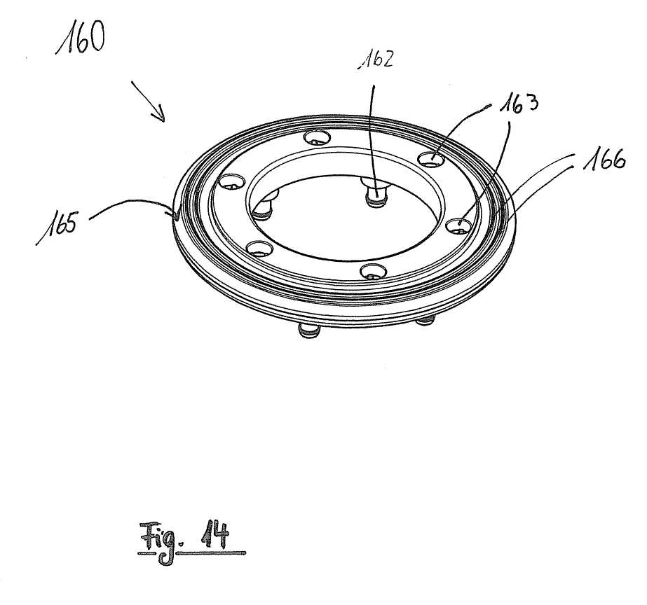

FIG. 14: is a perspective view of a connecting element.

A membrane 1 according to the invention is illustrated in FIGS. 1 and 2. Particles and colloids with diameters as low as 0.1 μm are retained in this membrane 1. The membrane 1 is primarily composed of a three-dimensional fiber framework 2 composed of fibers 4.55% of the dry weight of the membrane 1 is made up of the fiber fabric 4 and resin. 15% of the weight thereof is made up of chitin fibers and the rest of cellulose fibers. A proportion of 7% of the cellulose fibers is hemp fibers, and the remaining fibers are customary wood cellulose fibers. The average fiber length of the wood cellulose fibers 4 is approximately 1.5 mm. The hemp fibers are, with a length of up to 6 mm, significantly longer and have a stabilizing effect. The fibers have, depending on the desired throughflow rate, a freeness of, for example, 30-60SR. Polyamidoamine resin is used with a percent by weight of 6% as the wet strength agent.

Diatomaceous earth and perlites are embedded as additives 5 between the fibers 4. The percent by weight of the additives 5 is 45% of the dry weight of the membrane.

The thickness of the fiber framework 2 which is active in terms of filtering is 3.7 to 3.9 mm in the relaxed state. During operation, the membrane 1 is compressed to between 1.85 and 1.95 mm by the pressure gradient Δp (FIG. 3). The weight per unit area of the membrane is 1300 g/m². The resistance to tearing is 130 NM/50 mm.

The optional spacer element 3 which is loosely placed on the fiber framework which is active in terms of filtering is composed of polypropylene (PP) and has a thickness of 1 to 2 mm. The spacer element 3 is a mesh with openings of approximately 2×2 mm and does not have a filtering effect. It protects both the fiber framework 2 which is below it against damage by the unfiltrate U and forms ducts for the unfiltrate-side crossflow. Suitable spacer elements are, for example, the product with the number 5.307 from Intermas or the product with the number XN 4510 from InterNet. These products are preferred owing to the triplanar structure since the unfiltrate is favorably channelled.

So that the fiber framework 2 is not damaged by the spacer element 21 during operation, for example as a result of the grating structure penetrating the fiber framework 2, a protective nonwoven (not visible) made of polyester with a thickness of approximately 0.2 mm is inserted between the framework 2 and the spacer element 21. The spacer element 21 and the fiber framework 2 as well as the intermediate protective nonwoven are not permanently connected to one another but are pressed against one another during operation by the pressure gradient Δp (FIGS. 3b, 4b). It is furthermore also conceivable to provide a protective nonwoven between the fiber framework 2 and the unfiltrate-side spacer element 3.

FIGS. 3a and 3b show the structure of a crossflow filter system and the crossflow filtration principle schematically. The liquid to be filtered is located as an unfiltrate U in an unfiltrate tank 6. The unfiltrate U is fed with a feed pump 9. The unfiltrate U is circulated at a speed of approximately 1 m/s in circulation 11 with a process pump 10. The filtration takes place in the modules 30 in which membranes 1 are located in module elements which are stacked one on the other (FIG. 3b). The filtrate F is fed into a filtrate tank 7 via an outflow 8.

The pressure gradient Δp of typically 1 bar between an unfiltrate space 12 and a filtrate space 13 causes liquid to pass through the membrane 1. The pressure gradient is set by the suitable regulating arrangement R which controls the feed pump 9 and the process pump 10. The flow rate v of the unfiltrate can be regulated by means of the pressure gradient Δp.

Part of the unfiltrate U is forced through the membrane 1 as a result of the pressure gradient Δp. Some of the particles of the unfiltrate are retained at the surface of the membrane, while others remain in the depth of the membrane 1. As a result, the liquid is filtered in two ways as it passes through the membrane. The filtrate F which emerges is discharged into an outflow 8.

The membrane 1 is built into a module element 20 (FIGS. 4a-4d) which can be easily replaced. This simplifies the maintenance of the filter.

A module element 20 according to the invention and the installation of the module element 20 in modules 30 with a housing is illustrated in FIGS. 4a to 4d.

The module element 20 and the module 30 are illustrated in plan view in FIG. 4a. The module 30 has a housing with an essentially circular cross section. The unfiltrate is fed into the housing and discharged from it through two ports 31. The unfiltrate is located in the unfiltrate spaces 32. Two discharge lines 33 are provided for discharging the filtrate. On the unfiltrate-side, the module element 20 is opened so that no seal is necessary between the unfiltrate spaces and the unfiltrate-sides of the membrane.

FIG. 4b shows a detail along the section A-A from FIG. 4a. A module element 20 is illustrated in the region of the filtrate outflow 33. The module element 20 comprises two membranes 1. As described in conjunction with FIGS. 1 and 2, the membranes 1 comprise essentially a fiber framework 2 which is provided with a spacer element 3 on the unfiltrate-side. The spacer element 3 of the two membranes 1 point away from one another.

Between the two membranes 1 there is a further spacer element 21. The latter is composed in turn of a mesh composed of PP. Between the spacer element 21 and the fiber framework 2 there is a protective nonwoven (not shown). The spacer element 21 serves to channel the filtrate F and to set a constant distance between the two membranes 1. The protective nonwoven prevents ingress into the fiber framework. Since the spacer element 21 does not have to provide a protective function for the membranes 1, a larger size of 2 to 2.5 mm can be selected for the holes. In this case, a spacer element such as, for example, the product with the number XN4510 from Internet is suitable. The spacer element 21 extends into the filtrate outflow 33 so that the filtrate is conducted to there.

A transmembrane pressure Δp is applied across the membrane 1. The unfiltrate U flows over the membrane 1. Part of the unfiltrate is forced through the membrane 1 as a result of the pressure gradient Δp and in the process is filtered as described above.

The fiber framework 2 and the spacer element 3 are connected to a connecting piece 50 in a connecting region 40. The connecting piece 50 is configured in such a way that the module element 20 and the module stack formed from module elements 20 in the housing can be exchanged quickly and simply. A plurality of module elements 20 are assembled to form a stack composed of module elements. One or more such stacks are inserted together into the housing.

The two membranes 1 are pressed together in their edge regions by the connecting piece 40. The connecting piece 40 is embodied as an injection molded part. The filtrate outflow 33 is arranged in the connecting piece 40. The connecting piece can be embodied, for example, from two parts. The two parts can be connected to one another by bonding, welding, clamping or plugging. However, it is also conceivable to encapsulate the membranes of a module element 20 with a connecting piece by injection molding.

The design of such module elements 20 permits a plurality of module elements or element stacks to be arranged within the housing 30. The individual filtrate outflows 33 are arranged one on top of the other and connected to one another in a seal-forming fashion so that a continuous filtrate outflow is produced. Owing to the spacer elements 3 between adjacent module elements 20, ducts which open into the unfiltrate spaces 32 are formed for the unfiltrate. Unfiltrate U flows (see left-hand side in FIG. 4a) through over one 32 of the unfiltrate edges between the membranes 1 of adjacent modules. During this tangential overflow, part of the unfiltrate passes, as described, through the membrane 1 and is filtered in the process. The rest of the unfiltrate flows across the membrane 1 and enters the unfiltrate space 32 again (see right-hand side in FIG. 4a). The unfiltrate U is fed back in circulation again from the right-hand unfiltrate outlet to the supply on the left-hand side of FIG. 4a.

FIG. 4c illustrates the housing 30 in a lateral view. The housing 30 is essentially cylindrical. In each case four ports 31 are provided for feeding in and discharging the unfiltrate U. An outflow 34 for the filtrate F into which the outflow lines 33 open can also be seen. 100 module elements 20 are layered one on top of the other in the interior of the housing 30. It is possible, for example, to use 100 individual module elements 20 or 20 element stacks with five module elements. Each of the modules is installed in the housing, as described previously with respect to FIGS. 4a and 4b. The module elements 20 lie one on top of the other in a seal-forming fashion so that the spacer elements 3 of two adjacent module elements 20 form unfiltrate ducts between the module elements 20. The unfiltrate U then flows tangentially along the membrane surface between the module elements 20.

FIG. 4d illustrates how a plurality of housings 30 can be joined together in a serial and parallel arrangement in a filter system.

In this example, each module element 20 comprises two membranes 1. Of course, it is also conceivable to provide module elements 20 with a plurality of membranes 1.

An alternative embodiment of a module element 20 is illustrated in FIG. 5. Functionally identical components are referred to by the same reference symbols as in the exemplary embodiment according to FIGS. 4a to 4d.

In this embodiment, the module element 20 is embodied as a winding module. The fiber framework 2 is wound around a filtrate outflow 33. In this way a cylindrical module element 20 is produced. At the same time, a spacer element 3 is positioned on the unfiltrate-side, and a spacer element 21 is positioned on the filtrate side between the windings of the fiber framework 2. The unfiltrate U flows over the membrane in the longitudinal direction of the cylinder. The filtrate is conducted perpendicularly thereto in a helical shape into the center of the filtrate outflow 33. The terminating piece 35 serves to stabilize the module and is suitable for simple installation in a module 30.

Because of the cylindrical basic shape of the module element 20 from this exemplary embodiment, a cylindrical module 30 (not illustrated) is suitable in an analogous way to FIG. 4. The cylindrical shape of the module 30 is preferred within the housing owing to the optimum pressure distribution, but other shapes are also conceivable.

Tests with membranes according to the invention have shown that the flow rates can be kept constant over a long time without regeneration. With an overflow rate of 1 m/s it has been possible, for example when filtering beer, to keep the average flow to a value of approximately 150 l/m² h over a time of 480 minutes. A measuring sequence is shown by way of example in FIG. 6. In the process, the transmembrane pressure in the course of time had to be increased only from approximately 0.5 bar to somewhat less than 1 bar. A retention which corresponds comparably to the retention rate of conventional plastic or ceramic membranes with a pore diameter of approximately 0.1 μm to 0.2 μm was achieved with the membrane constructed as shown in FIGS. 1 and 2. For this purpose, a membrane 1 which is constructed from a fiber framework 2 was used. The fibers were selected in such a way that measured pore sizes (measurement by means of a capillary flow analysis measuring device CFP-1100-A from Porous Materials Inc, Itaka, N.Y., USA) with water as the measuring liquid are produced as follows:

| Minimum | Mean | Maximum |
|---|---|---|
| pore size | pore size | pore size |
| 0.82 | 4.05 | 15.57 |

FIG. 7 shows a plan view of a module element 120 according to the invention with an unfiltrate spacer element 103 resting on it. The module element 120 has a centrally arranged filtrate outflow 133.

The edge region 139 of the module element 120 is encapsulated by injection molding in a liquid-tight fashion so that a frame 141 is formed. Pins 142 and recesses 143 for connection to further module elements are provided on the frame 141.

FIG. 8 shows a sectional view of a stack 100 of two module elements 120 along a section plane A-A in FIG. 7. Each module element 120 is composed of a filter cushion 115, a connecting element 160 and an unfiltrate spacer element 103. The filter cushion 115 is in turn constructed from two membranes 101 and a filtrate spacer element 121. A filtrate discharge duct 125 is formed on the filtrate side between the membranes 101.

In the edge region 139 the filter cushion 115 has a frame 141. A further connecting element 160″ is located on the uppermost filter cushion 115. Said connecting element 160″ can serve as a closure for the entire stack 100 or for connecting to a further filter cushion (not illustrated in the figure).

FIG. 9 shows an enlarged detail C of the illustration in FIG. 8 with connecting elements 160, 160′, 160″ placed one on top of the other. A connecting element 160 has closure elements on both sides, said elements being embodied in the example shown in the figure as pins 162 and recesses 163, and being intended for connection to further connecting elements 160′. The connecting elements 160, 160′ which are shown in the figure each have six pins 162 and six recesses 163 arranged between them. The pins 162 of a connecting element 160 engage in the recesses 163 of the connecting element 160′ arranged above it, as a result of which a snap-fit closure is produced. The connecting elements 160, 160′, 160″ are identical in terms of their external shape. They are stacked alternately one on top of the other, each rotated through 30 degrees with respect to one another, with the result that the pins 162 meet the recesses 163 which are located between the pins 162.

The connecting element 160 has a bearing face 164 with which it bears around the central discharge region 122 of the abuts cushion 115 on the membrane 101. Parallel to this there is a further bearing face 165 for a further filter cushion 115′ (not shown here) to abut against. The distance 166 between bearing faces 164, 165 of adjacent connecting elements 160, 160′ is dimensioned in such a way that the filter cushion 115 is permitted to become clamped between the bearing faces 164, 165 in the discharge region 122. Consequently it is not possible for unfiltrate which is located between adjacent filter cushions 115, 115′ to get into the filtrate outflow 133.

Projections (not shown in the figure) which press into the membrane can be located on the bearing faces 164, 165. The filter cushion 115 is also held between the bearing faces 164, 165 when fluid flows through. It is ensured that no unfiltrate gets into the filtrate outflow 133.

FIG. 10 shows an enlarged detail D of the illustration in FIG. 8 with the edge regions 139 of the filter cushion 115. The filtrate spacer element 121 has a stop 123 in the edge region 139. The stop 123 is embodied as a stop face 124 which is arranged perpendicularly to the plane of the filtrate spacer element 121. The membranes 101 bear against the stop 123 in the edge region 139 and are together encapsulated by injection molding and enclosed by a frame 141.

FIG. 11 shows an edge region 139, embodied in an alternative way, of the filter cushion 115 in which the filtrate spacer element 121 has a seal-forming closure 126 in the edge region 139. The seal-forming closure 126 seals off the space between the membranes 101 in the edge region 139. In addition, the filter cushion in the edge region 139 is also encapsulated by injection molding, forming a frame 141.

FIG. 12 shows a schematic sectional illustration of a plurality of stacked module elements 120 along a section plane B-B in FIG. 7. On the frame 141 which is attached by injection molding, the module elements 120 have alignment elements 144 which are embodied as pins 146 and recesses 147. The pins 146 and recesses 147 of adjacent module elements 120 engage one in the other. The alignment elements 144 support the correct positioning of the module elements 120 during stacking and contribute to maintaining the positioning when liquid flows through the stack. Additional attachment elements which engage from the outside are not necessary.

FIG. 13 shows a perspective view of a stack 100 of module elements 120 with unfiltrate spacer element 103 which rests on them at the top. The unfiltrate spacer element 103 has a groove structure by means of which unfiltrate is conducted from an inflow region 134 to an outflow region 135. In the process, there is a uniform flow around the membrane surface of the module element 120, and the filtrate outflow 133 is excepted.

The unfiltrate spacer element 103 is equipped with positioning tongues 136 which engage in corresponding recesses on the frame 141 of the module element 120. The positioning tongues 136 make mounting easier when stacks are formed and prevent the unfiltrate spacer element 103 from shifting when liquid flows through the stack.

The unfiltrate spacer element 103 is an injection-molded part which is preferably fabricated from polypropylene. The same applies to the filtrate spacer elements which are not shown explicitly in this figure.

The connecting elements 160″ are manufactured from glass fiber-reinforced polypropylene.

The membranes 101 are also encapsulated by injection molding with a glass fiber-reinforced polypropylene in an injection mold so that a rigid frame 141 is produced.

Basically all the plastics which can be used in injection molding, such as thermoplasts, elastomers and duroplasts, are possible for the spacer elements 103, the connecting elements 160″ and the frames 141. In particular polypropylene, PSU and PES are suitable for application in the filtration of beverages. The same material or at least materials with the same thermal expansion should be used for all parts.

Typical basic dimensions of the membranes are a length of 385 mm and a width of 287 mm so that a filter cushion with two membranes has a filter surface of approximately 0.2 m². Of course, it is also possible to fabricate module elements with smaller or larger filter surfaces.

FIG. 14 shows a perspective illustration of a connecting element 160. The closure elements are embodied as pins 162 and recesses 163. The connecting element 160 has a bearing face 165 for a membrane (not shown in the figure). Two annular projections 166 which press into the membrane are arranged on said bearing face 165.

1-43. (canceled)

44. A crossflow filter membrane, wherein the membrane has an active layer of at least 1 mm, for best results at least 2 mm thickness.

45. The crossflow filter membrane as claimed in claim 44, wherein the membrane is embodied over its entire thickness as a layer which is active for filtration.

46. The membrane as claimed in claim 44, wherein the membrane is composed of a three-dimensional framework, in particular composed of fibers, for best results of cellulose fibers.

47. The membrane as claimed in claim 46, wherein the three-dimensional framework is consolidated by a resin.

48. The membrane as claimed in claim 44, wherein the membrane is constructed in such a way that its retention rate corresponds to the retention rate of conventional plastic or ceramic membranes with a pore size of 0.2 μm to 1.2 μm when filtering beer.

49. The membrane as claimed in claim 45, wherein the fibers have a length of 0.5 to 10 mm.

50. The membrane as claimed in claim 44, wherein additives, in particular diatomaceous earth and/or perlites, are embedded in the membrane.

51. The membrane as claimed in claim 44, wherein the membrane is reversibly compressible.

52. The membrane as claimed in claim 44, wherein the membrane is provided with a spacer element, in particular on the unfiltrate-side surface.

53. The membrane as claimed in claim 52, wherein a protective layer, in particular a woven or nonwoven is arranged between the spacer element and the filter layer.

54. The membrane as claimed in claim 44, wherein the structure of the membrane is nonhomogenous with respect to a direction perpendicular to the surface of the membrane, in that in particular the fiber density, fiber lengths and at most additives embedded in the membrane are distributed nonhomogenously.

55. The membrane as claimed in claim 54, wherein the fibers and/or additives are distributed in such a way that in a filtrate-side region of the membrane finer particles are filtered out of the unfiltrate comparted to the unfiltrate-side region of the membrane.

56. A module element for installation in a crossflow filter, wherein the module element contains at least one membrane as claimed in claim 44.

57. The module element as claimed in claim 56, wherein the module element has two membranes, wherein a filtrate discharge duct is formed on the filtrate side between the membranes.

58. A module element having a filter cushion composed of two filter membranes which are arranged parallel to one another, wherein a filtrate discharge duct is formed on the filtrate side,
having at least one discharge region for carrying away permeate, which has collected in the filtrate discharge duct, into a filtrate outflow,
wherein the module element comprises at least one connecting element which defines the filtrate outflow,
which abuts against an unfiltrate-side surface of the filter cushion adjacently to the at least one discharge region,
by means of which a region in which unfiltrate is located can be closed off in a seal-forming fashion from the filtrate outflow, and
which has at least one closure element for positively locking engagement with at least one closure element of at least one further connecting element.

59. The module element as claimed in claim 58, wherein the connecting element can be connected on both sides to at least one connecting element of the same type of at least one further module element.

60. The module element as claimed in claim 58, wherein the at least one closure element comprises pins and recesses, wherein recesses serve to accommodate pins of an adjacent connecting element and to form the snap-fit closure.

61. The module element as claimed in claim 58, wherein projections which hook into the membrane are provided on the at least one connecting element.

62. The module element as claimed in claim 58, wherein an edge region of the filter cushion which comprises the entire edge of the filter cushion apart from the at least one discharge region is closed off in a liquid-tight fashion, for best results by injection molding or fusing.

63. The module element as claimed in claim 62, wherein alignment elements, in particular pins and recesses, for positively locking engagement with an adjacent module element are arranged on the edge region.

64. The module element as claimed in claim 58, wherein the discharge duct is formed by a filtrate spacer element.

65. The module element as claimed in claim 64, wherein the filtrate spacer element has, at least in part of its edge region, at least one stop against which at least one membrane abuts.

66. The module element as claimed in claim 64, wherein the edge region of the filter cushion which comprises the entire edge of the filter cushion apart from the at least one discharge region is closed off by the filtrate spacer element in a liquid-tight fashion.

67. The module element as claimed in claim 64, wherein nonwoven inlays are located between the membranes and the filtrate spacer element.

68. The module element as claimed in claim 64, wherein plastic membrane inlays, for best results with a pore size between 0.1 μm and 0.6 μm, are located between the membranes and the filtrate spacer element.

69. The module element as claimed in claim 58, wherein at least one plastic membrane inlay, for best results with a pore size between 0.1 μm and 0.6 μm, is located in the flow cross section of the filtrate discharge duct of the module element.

70. The module element as claimed claim 58, wherein a filtrate spacer element forms a filtrate duct by means of which the filtrate can be conducted laterally through a connecting piece and into a filtrate outflow.

71. The module element as claimed in claim 58, wherein a duct for unfiltrate is formed between the unfiltrate-side surfaces of adjacent membranes.

72. The module element as claimed in claim 71, wherein the duct for the unfiltrate is formed by an unfiltrate spacer element.

73. The module element as claimed in claim 72, wherein an unfiltrate space which is formed between the unfiltrate-side surfaces of adjacent membranes is opened on the side of the module.

74. The module element, in particular as claimed in claim 72, wherein the module element has an unfiltrate spacer element with a groove structure through which the unfiltrate can be conducted across the membrane surface and for best results past the discharge region.

75. The module element as claimed in claim 72, wherein the unfiltrate spacer element has positioning tongues which engage in corresponding recesses in the edge region of the filter cushion.

76. The module element as claimed in claim 72, wherein the unfiltrate spacer element is an injection-molded part.

77. A connecting element for connecting adjacent filter cushions composed of two filter membranes which are arranged parallel to one another, wherein a filtrate discharge duct is formed on the filtrate side between the membranes, having at least one discharge region for carrying away permeate which has collected in the filtrate discharge duct, said filtrate discharge duct opening into a filtrate outflow, wherein
adjacent to the at least one discharge region, the connecting element can be applied to an unfiltrate-side surface of the filter cushion;
a region in which unfiltrate is located can be closed off in a seal-forming fashion with respect to the filtrate outflow by means of the connecting element; and
the connecting element has at least one closure element for a positive locking engagement with at least one closure element of at least one further connecting element.

78. The connecting element as claimed in claim 77, wherein the connecting element can be connected on both sides to at least one connecting element of the same type of at least one further module element.

79. A method for manufacturing a module element, comprising the following method steps:
stacking of a first membrane, a filtrate spacer element and a second membrane;
encapsulation by injection molding of the edge, with the exception of the at least one discharge region; and
applying connecting element.

80. A module for crossflow filtration, wherein it is composed of a stack of 2-100 module elements as claimed in claim 58.

81. A method for crossflow filtration of a liquid, in particular of a drink, wherein the liquid is conducted along a membrane as claimed in claim 44.

82. The method as claimed in claim 81, wherein the liquid is conducted across or through the membrane with a flow rate between 0.1 and 2 m/s and/or with a transmembrane pressure of 0.01 to 2 bar, for best results approximately 1 bar.

83. The method as claimed in claim 81, wherein the rate of flow through the membrane is regulated, in particular by adjusting the transmembrane pressure.

84. A method for filtering a liquid, in particular a beverage, wherein the liquid is filtered in a crossflow mode across a membrane, and in that the part of the liquid which passes transversely through the membrane, in particular as claimed in claim 44, is additionally filtered in the depth of the membrane as it passes through the membrane.

85. A method for cleaning a crossflow filter membrane, in particular as claimed in claim 44, wherein, for the purpose of cleaning, the transmembrane pressure is reduced transversely with respect to the membrane compared to the transmembrane pressure during the filtration, as a result of which the membrane expands, and in that parts which are deposited in the membrane are removed with a cleaning fluid.

86. The method as claimed in claim 85, wherein the transmembrane pressure is reduced by at least 50%.
